(19) United States
(12) Patent Application Publication
(10) Pub. No.: US 2026/0200148 A1
(43) Pub. Date: Jul. 16, 2026

(54) POLYMER AMMUNITION CASING MOLD AND MANUFACTURING METHOD

(71) Applicant: Innovative Performance Applications, LLC, Orange, CA (US)

(72) Inventor: John Cogger, Santa Ana, CA (US)

(73) Assignee: Innovative Performance Applications, LLC, Orange, CA (US)

(21) Appl. No.: 19/445,622

(22) Filed: Jan. 12, 2026

Related U.S. Application Data
(60) Provisional application No. 63/746,207, filed on Jan. 16, 2025.

(51) Int. Cl. B29C 45/26; B29C 45/36; B29C 45/40; B29K 67/00; B29K 69/00; B29L 31/00

(52) U.S. Cl. CPC B29C 45/2616; B29C 45/36; B29C 45/401; B29C 2045/366; B29K 2067/006; B29K 2069/00; B29L 2031/7772

(57) ABSTRACT

An injection mold for manufacturing an injection molded polymer casing includes five separate mold portions cooperatively delimiting a casing’s volume. A base mold portion has an annularly shaped base cavity surface, a primer retention feature core extending from the base cavity surface, and a flash hole core extending from the primer retention feature core. A first transverse mold portion has a first half cavity surface configured to form a first half of the outside cylindrical surface of the casing. A second transverse mold portion has a second half cavity surface configured to form a second half of the outside cylindrical surface of the casing. A core pin mold portion has a frustoconical core configured for forming the inside cylindrical surface of the casing. A sleeve ejector mold portion forms the open-end surface of the casing and has a through hole for the core pin mold portion to be disposed through.

### CROSS-REFERENCE TO RELATED APPLICATIONS

This non-provisional application claims priority to provisional application 63/746,207 filed on January 16, 2025, the entire contents of which is fully incorporated herein with this reference.

### DESCRIPTION

### FIELD OF THE INVENTION

The present invention generally relates to ammunition casings. More particularly, the present invention relates to an ammunition casing that is made with a polymer instead of a metal using a novel mold and manufacturing method.

### BACKGROUND OF THE INVENTION

Review of existing patent literature reveals over 200 patents issued for various aspects of producing polymer casings. Investigation of the details of some of these patents indicates that most or all of them relay on conventional injection molding as means of manufacture but require multipiece construction with multiple components because regions of the typical munitions cross section consist of necked down and tapered regions that will be impossible to injection mold due to the severe undercuts.

Review of these patents and associated claims leads to some common limitations. All are multi-piece casing designs due to the inherent difficulties in traditional injection molding. This requires some non-trivial means of attachment between the various pieces. Metal injection molding is claimed (MIM) with the same considerations and limitations as above. Many polymer-based resins are claimed but no reference to carbon nanotube additives or graphene platelet additives was found. Alternative projectile retention mechanisms are claimed, typically using molded in surface textures to increase surface friction. No mention can be found accommodating the inherent visco-elastic behavior of polymers under long term tension load, such as stress relaxation or creep. These phenomena conspire to the effect of loosening the projectile fit to the polymer casing over time.

Accordingly, there is a need for an improved casing utilizing polymers and not metals. The present invention fulfills these needs and provides other related advantages.

### SUMMARY OF THE INVENTION

U.S. application 18/312,794 filed on May 5, 2023 now U.S. Patent 12,066,279 issued August 20, 2024 and U.S. application 18/805,432 filed on August 14, 2024 now U.S. Patent 12,442,626 issued October 14, 2025 are fully incorporated herein with these references.

Reference is now made to provisional application 63/746,207 filed on January 16, 2025, which is incorporated herein with this reference and repeated herein below for consistency. The provisional application taught an additional embodiment of manufacturing the Polymer Ammunition Casing originally taught in U.S. Patent 12,066,279 B2 which was specific to the 30 caliber ammunition round.

The casing of the 30 caliber round is an injection molded polymer component approximately 32.766 mm long and by approximately 9.144 mm in diameter at the widest point. This particular casing has favorable draft angles on both internal and external surfaces allowing the part to strip axially off the mold core pin with no undercuts. Because of this lack of undercuts, the casing may be molded in one piece contrary to the previous teachings.

It is taught herein that the thickness of the casing walls is extremely thin and as such challenges conventional injection molding standards for thin wall molding. To successfully mold this part in the material of choice, several key elements were utilized. First, a single axial pin gate on the proximal end of the casing is positioned to encourage axial flow of the material along the length of the part as shown in FIGS. 2 and 3 of the ‘207 provisional application. Furthermore, a sleeve ejector on the distal end of the part which allows the part to strip off the core pin without damaging the thin casing wall as shown in FIG. 4.

Materials used for the single shot one piece molding of the 30 caliber casing include all materials listed in the original filing of the ‘794 and ‘432 applications. Now, this casing is molded from a base resin of PC/PBT (polycarbobate / polybutylene terephthalate) blend with discrete versions using a carbon fiber additive (10% let down ratio) and another version using 2% carbon nanotubes. The range in additive percentage by weight is as follows:

1) PC/PBT base resin. Any range of PC from 1%-99% with PBT comprising the remainder. PBT is polybutylene terephthalate.

2) PC/PBT w/carbon fiber with the carbon fiber additive in the range of ratios from 0.5% to 50%.

3) PC/PBT w/carbon nano tubes with the nanotube additive in the range of ratios from 0.5% to 50%.

The mold is best shown in FIG. 6 of the ‘207 provisional application. The mold is a conventional two plate injection mold with two opposing slides, perpendicular to the axial centerline of the casing, to form the outside diameter of the casing and an internal drafted core pin to axially pull the main internal diameter. The small internal cup feature for the primer location is formed on the fixed (A) side of the mold and incorporates the tunnel gate. This fixed pin also serves to pilot into the long (B) side core pin, to ensure concentricity and stability, eliminating the tendency for the long core pin to deflect due to melt front pressure.

To eject, the mold opens and by means of two angle pins, the slides then pull away from the casing outside diameter. The molded casing sticks on the core pin, fixed to the moving side of the mold (B side), and the ejector sleeve pushes the casing off the core pin without introducing buckling or distortion on the casing. The sleeve has a partial ejection throw, and a solenoid air blast clears the molded part off the remainer of the core pin. The finished casing can also be removed by means of EOA (end of arm) robotic unloader. Alternatively, the ejector sleeve can be designed to provide full length ejection off the end of the core pin with no air blast needed.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a partial cross-sectional view of a typical ammunition cartridge;

FIG. 2 is a cross-sectional view of a 7.62 mm casing;

FIG. 3 is a cross-sectional view similar to FIG. 2 now with a bullet and primer cap attached;

FIG. 4 is a cross-sectional view of the casing manufactured by the injection mold of the present invention;

FIG. 5 is an isometric view of the injection mold of the present invention;

FIG. 6 is a cross-sectional view of the structure shown in FIG. 5 where now the injection mold is in a molding state;

FIG. 7 is an enlarged view of the structure of FIG. 6 showing the interface between the base mold and core pin;

FIG. 8 is an enlarged view similar to FIG. 7 but show illustrates an alternative embodiment where the core pin interfaces into the base mold;

FIG. 9 is similar to FIG. 6 but now shows the casing molded;

FIG. 10 shows how the left and right mold portion are first removed;

FIG. 11 is after FIG. 10 and now shows the base mold removed; and

FIG. 12 is after FIG. 11 and now shows the casing ejected off the frustoconical core by the sleeve ejector mold portion.

### DETAILED DESCRIPTION OF THE PREFERRED EMBODIMENTS

Reference is now made to the figures of this non-provisional application.

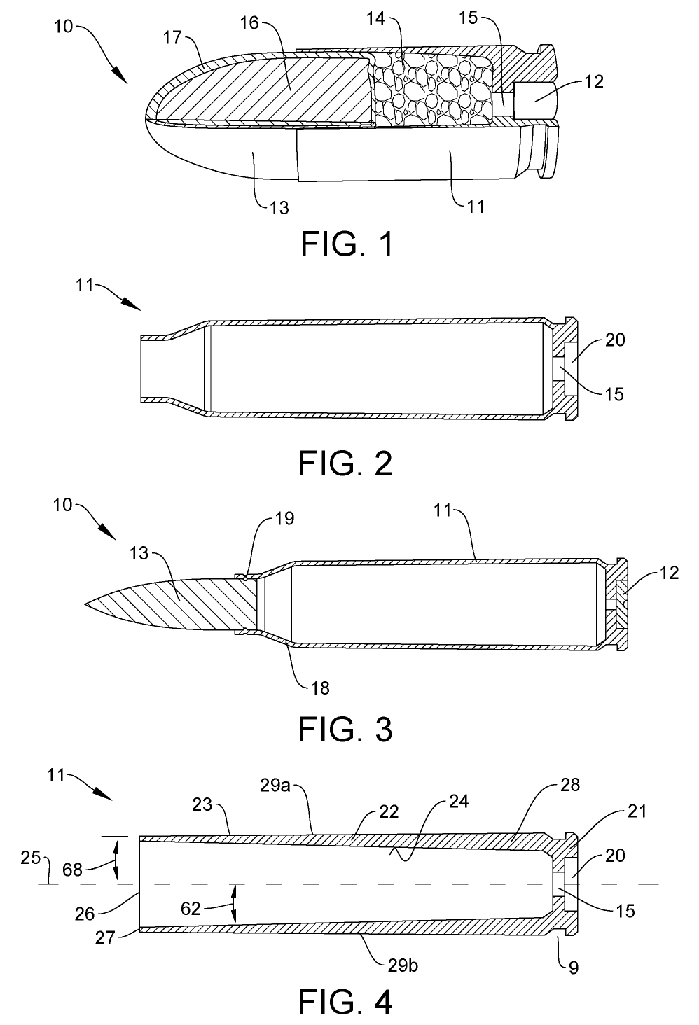

Often, people mistakenly refer to an ammunition cartridge as a bullet, yet the bullet is typically just one of four parts that form the ammunition cartridge. FIG. 1 shows the four main parts of an ammunition cartridge 10, which are the casing 11, the primer 12, the projectile 13 (i.e., the bullet) and the propellant 14 (i.e., gunpowder).

The Casing: A bullet’s casing is the metal shell that encases the bullet’s propellant. It is usually made of brass, although steel or aluminum casings are also used. The casing also holds the bullet’s primer, which ignites the propellant and causes the bullet to be fired from the gun. When a bullet is fired, the casing is ejected from the gun along with the spent primer. The casing can then be reloaded with a new primer and propellant and reused. When the primer explodes after being struck by the firing pin, the small explosion travels through the flash hole to then ignite the propellent inside the casing.

The Primer: A primer in a bullet is a small explosive charge that serves to ignite the powder in the cartridge. It is located at the base of the cartridge and is usually made of a material that is readily ignitable by heat or friction. When the trigger of a firearm is pulled, the firing pin strikes the primer, causing it to detonate. The resulting explosion ignites the powder within the cartridge, propelling the bullet out of the barrel. In order for a primer to function properly, it must be of the correct size and type for the particular caliber of ammunition being used. Additionally, the primer must be seated correctly in order to ensure reliable ignition. Improperly seated primers can cause misfires, which can be dangerous.

The Projectile: The projectile is the part of the bullet that actually strikes the target. It is usually made of lead 16, although other materials such as steel or copper can also be used. The lead 16 may also have a metal jacket 17. The projectile is seated on top of the propellant within the cartridge. When the primer is detonated, the resulting explosion ignites the propellant and propels the projectile out of the barrel. The projectile continues to travel forward until it strikes the target or runs out of kinetic energy.

The Propellant: Gunpowder, also known as black powder, is a type of explosive that is used in bullets. It consists of a mixture of sulfur, charcoal and potassium nitrate. When gunpowder is ignited, it rapidly expands and produces a large volume of gas. This gas is what propels the bullet out of the barrel. Gunpowder is very sensitive to heat and friction, so it must be carefully handled in order to avoid accidental detonation.

### Single Piece Polymer Ammunition Casing:

As explained earlier, the casing is typically made of metal. However, the inventors of the present application have developed a casing that is manufactured from a polymer. The invention described herein utilizes a novel plastic injection molding process to mold the casing while maintaining thin wall sections with high dimensional consistency in a single piece casing, similar to the single piece casing 11 shown in FIG. 2 which is a cross section of a 7.62 mm casing. FIG. 3 shows the casing of FIG. 2 with a bullet 13 and primer cap 12 attached but missing the propellant. A challenge for polymer-based munition casings is the requirement to use resins that can withstand the extremely high temperatures and pressure waves resulting from the firing event.

Review of the prior art for polymer casing design and production yields more than 200 existing patents. Most of these patents ignore the difficulties of injection molding polymer munition casings with necked or severely undercut regions. Several of the patents do attempt to accommodate the necked (i.e., undercut 18) region of the casing with a two-stage operation, where the first stage molds a straight wall axisymmetric cylinder and the second stage uses a thermoforming operation to produce the reduced diameter neck. Other approaches use a multi-piece casing design to eliminate the severe undercuts. Additionally, an insert molding operation is sometimes contemplated to overmold a metallic primer insert, but this is not really a single piece ammunition casing. Neither of the approaches is suitable for high volume production of a molded component with attendant precision thin walls. Also, various schemes have been proposed to help retain the projectile to the casing with sufficient retention force, where the typical annual retaining rib feature results in yet another undercut confounding molding. Alternatives such as molding high grip texture and other similar approaches show up in the patent literature. Additionally, the use of materials in the patent filings reviewed show no specific reference to high strength additives, such as graphene platelets or carbon nanotubes. The present invention teaches that the optimal solution for low-cost production of consumer grade polymer munitions lies with a combination of advanced material additives in a commodity base resin, combined with a high-speed manufacturing process of molding severe undercuts with precision thin walls resulting in a single, one-piece casing with consistent wall thicknesses.

FIG. 4 is a cross section of an exemplary injection molded polymer casing 11 manufactured from the injection mold of the present invention. The injection molded polymer casing comprise a base 21 having a primer retention feature 20 and a flash hole 15. A hollow cylindrical portion 22 has an outside cylindrical surface 23 opposite an inside cylindrical surface 24 that extends from the base along an axial centerline 25 to an open end 26 having an open end surface 27. The inside cylindrical surface is a frustoconical shape having a draft angle Ө (reference numeral 62) such that a core can be removed from within the hollow cylindrical portion. FIG. 4 exaggerates the severity of the draft angle for the reader’s understanding but the draft angle can be anything over 0 degrees, such as 0.10 degrees, 0.25 degrees, 0.50 degrees, 1 degree, 2 degrees, and so on. It is understood that the casing has a casing’s volume 28 made of the polymer of the present invention. Near the base 21, there is also an annular channel 9 formed on the outside cylindrical surface 23.

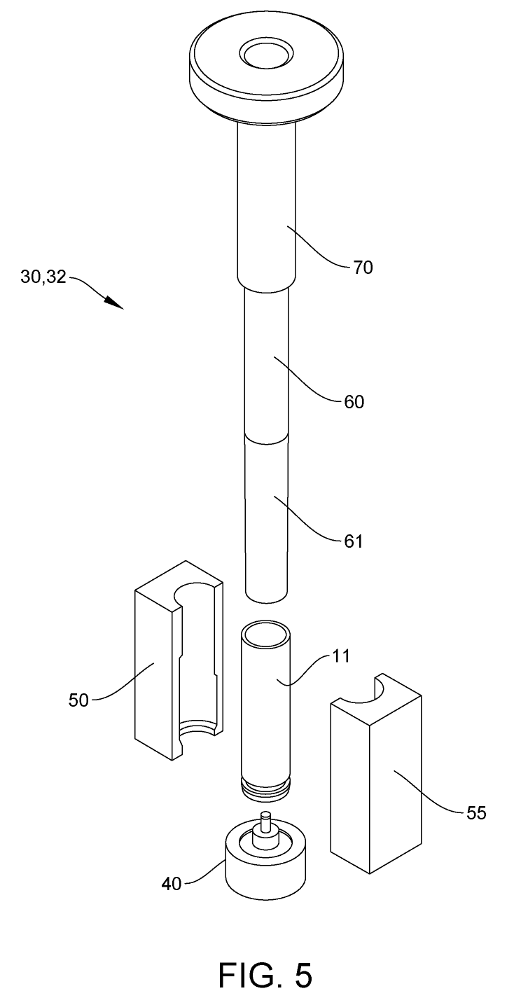

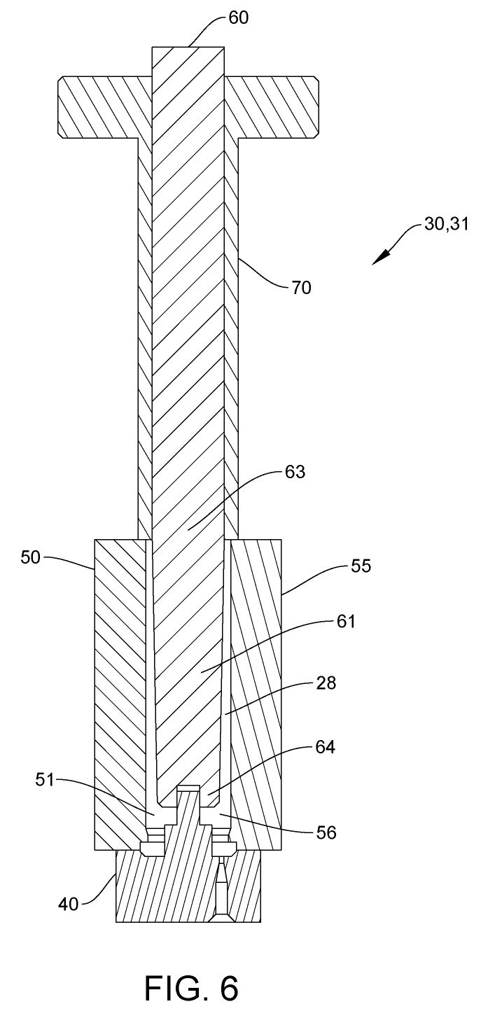

FIG. 5 is an isometric view of the injection mold 30 of the present invention in an expanded state which is similar to a release state 32 such that the casing 11 can be extracted from the mold. FIG. 6 is a cross section of the structure of FIG. 5 when the injection mold is in a molding state 31. As shown in FIG. 6 the five separate mold portions cooperatively delimiting the casing’s volume 28. The injection mold 30 has a base mold portion 40, a first transverse mold portion 50, a second transverse mold portion 55, a core pin mold portion 60 and a sleeve ejector mold portion 70.

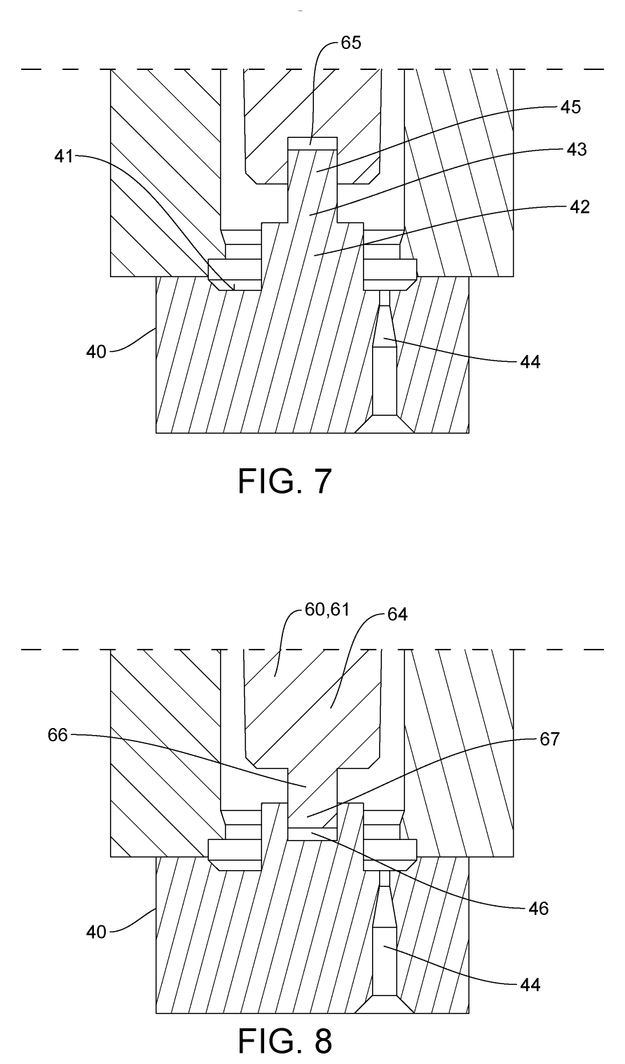

The base mold portion 40 is best seen in FIG. 7 which is an enlarged sectional view taken from FIG. 6. The base mold portion 40 has an annularly shaped base cavity surface 41. A primer retention feature core 42 extends from the base cavity surface. A flash hole core 43 extends from the primer retention feature core. An injection gate 44 is fluidically connected to the base cavity surface 41. The injection gate 44 is configured for injecting a melted polymer under pressure into the injection mold. In this embodiment, the injection gate 44 is the only injection gate of the injection mold. It will be understood by those skilled in the art that a plurality of injection gates could be integrated feeding into the base cavity surface 41, such as 2, 3, 4 or any number of gates being radially integrated and equally spaced around the axial centerline.

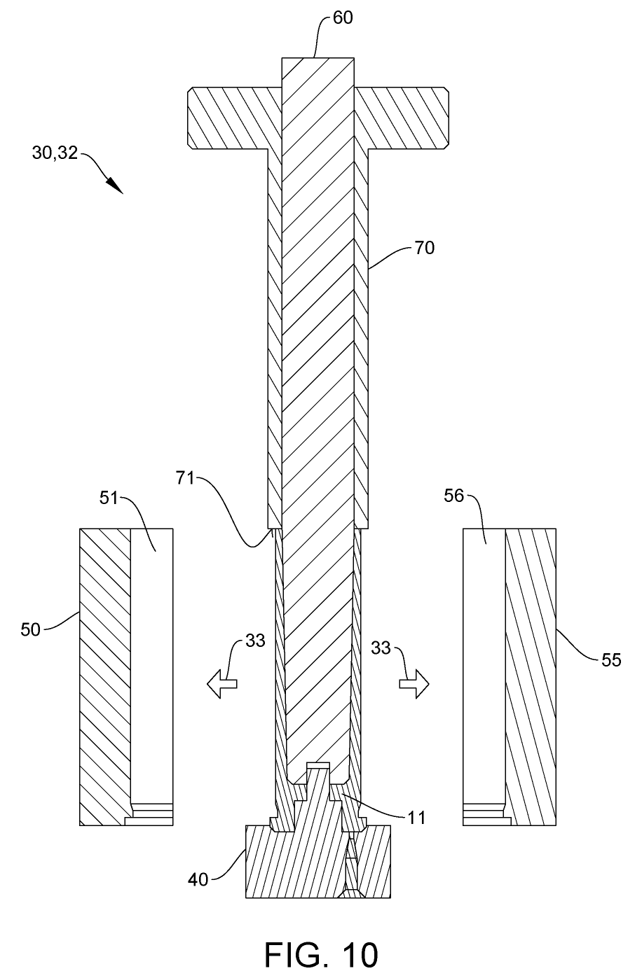

As best seen in FIGS. 6 and 10, a first transverse mold portion 50 has a first half cavity surface 51 configured to form a first half 29a of the outside cylindrical surface of the injection molded polymer casing. Likewise, a second transverse mold portion 55 has a second half cavity surface 56 configured to form a second half 29b of the outside cylindrical surface of the injection molded polymer casing. As seen in FIG. 10, the first transverse mold portion and the second transverse mold portion are configured to move away from one another in a direction perpendicular 33 to the axial centerline of the injection molded polymer casing. Due the movement of the first and second transverse mold portions, annular channel 9 can be formed on the outside of the injection molded polymer casing.

Referring to FIG. 6, a core pin mold portion 60 has a frustoconical core 61 configured for forming the inside cylindrical surface of the injection molded polymer casing. The frustoconical core has a cylindrically shaped narrowing draft angle 62 configured to allow axial withdrawal (i.e., less than zero degrees) that narrows starting from a frustoconical core proximal end 63 and moving towards a frustoconical core distal end 64.

A sleeve ejector mold portion 70 has an annularly shaped top surface cavity surface 71 configured for forming the open end surface of the injection molded polymer casing. The sleeve ejector mold portion has a through hole 72 wherein the core pin mold portion is configured to be disposed through the through hole of the sleeve ejector mold portion. The core pin mold portion is configured to move away from the base mold portion in a direction aligned 34 along the axial centerline of the injection molded polymer casing. The sleeve ejector mold portion is also configured to move away from the base mold portion in the direction aligned 34 along the axial centerline of the injection molded polymer casing.

As best shown in FIG. 7 a flash hole core distal end 45 is configured to be at least partially disposed within a frustoconical core distal end cavity 65. This is important because it keeps the core pin mold portion aligned despite the significant amount of forces being imparted during the molding operation. This key aspect keeps the mold portions aligned to achieve the thin wall sections of the casing of the present invention.

FIG. 8 is an alternative embodiment in contrast to FIG. 7. FIG. 8 now illustrates that a flash hole core 66 extends from the frustoconical core distal end 64 of the core pin mold portion 60,61. Now, a flash hole core distal end 67 is configured to be at least partially disposed within a primer retention feature core cavity 46. Similarly, this key aspect keeps the mold portions aligned to achieve the thin wall sections of the casing of the present invention.

A method of manufacturing the injection molded polymer casing for the ammunition cartridge is taught using the injection mold of the present invention. The method comprises the steps of: a) providing the injection mold comprising the five separate mold portions; b) moving the five separate mold portions into the molding state; c) injecting the melted polymer under pressure through the injection gate into the injection mold; d) waiting a period of time for the melted polymer to solidify through cooling; e) moving at least one of the five separate mold portions away from one another to the release state; and f) removing the casing from the injection mold.

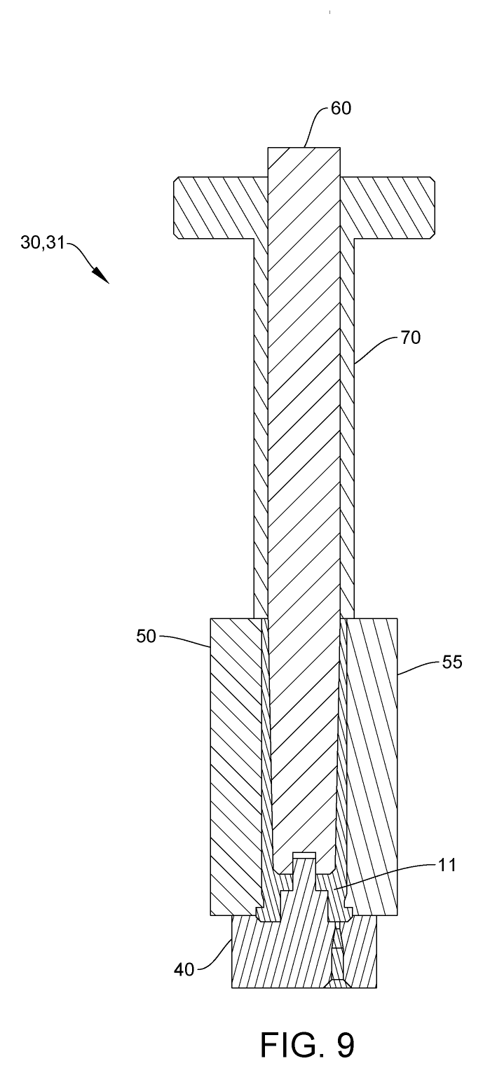

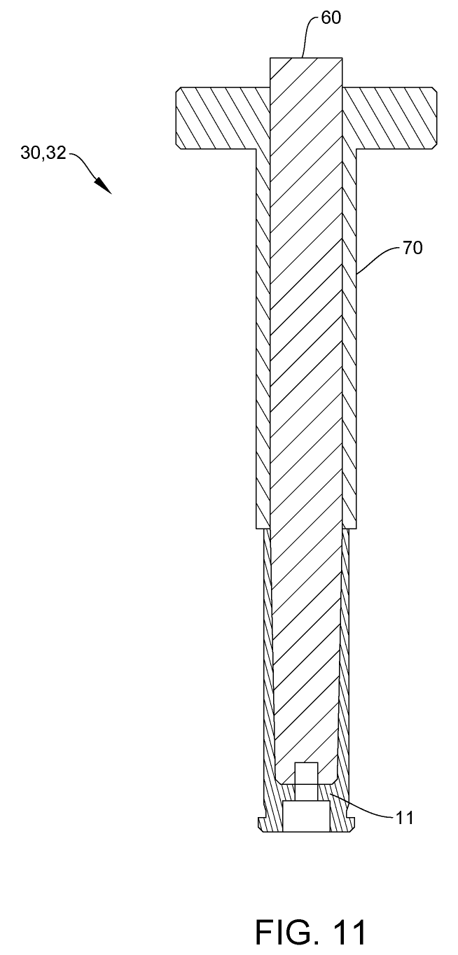

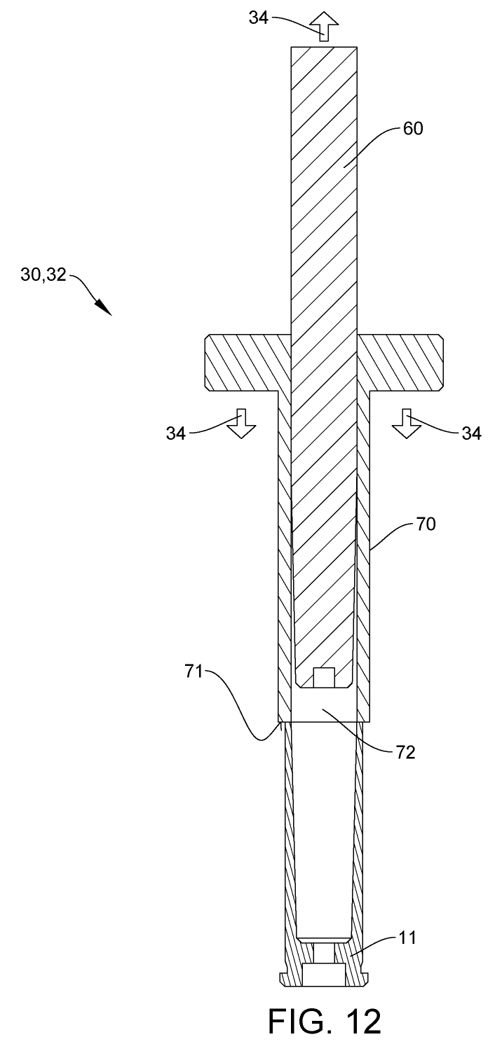

FIG. 9 shows that the casing 11 of the present invention has been molded inside the mold of the present invention. FIG. 10 shows that the mold portions 50 and 55 are moved in a direction 33 that is perpendicular to the axial centerline. FIG. 11 shows that the base mold portion can then be removed. FIG. 12 shows that the core pin mold portion can be moved in a direction 34 away from the sleeve ejector mold portion such that the sleeve ejector mold portion slides the casing 11 off the frustoconical core 61.

When the mold portions 50 and 55 open the core pin, sleeve ejector and casing are now attached to the moving half of the mold, and the casing now has clearance (but is still constrained) by gravity to drop out of the mold envelope, or alternatively, be picked out by a robot arm. The molded polymer cartridge shrinks tightly around the male core pin and must be freed to allow either gravity drop or robotic extraction. Typically, the core pin is fixed to the moving half of the mold, and the concentric sleeve ejector travels with it, but is actuated independently. The concentric sleeve ejector mold portion can use either a hydraulic cylinder to actuate axially, stripping the part from the core pin, or may be actuated by a spring mounted against a stop on the moving half of the mold, then forcing the sleeve to eject the part at the end of the mold open stroke.

If hydraulic cylinder actuation is chosen, the ejection cycle may be divorced from the mold open stroke, e.g., the ejection stroke can be controlled independently from the stroke by PLC control. If the mechanical spring method is chosen, the mold is simpler, but the ejection timing is now inexorably tied to the mold stroke. In most cases it is likely the mechanical spring system would be used.

An air blast may be used to facilitate the demolding as this typically is applied through the center of the core pin. When the mold is closed, a (core pin) center air channel is sealed off from the cavity by the small core pin in the fixed side of the mold near the gate. When the mold is opened, the part, core pin, and ejector sleeve pull away from the fixed side of the mold as described earlier. When the sleeve ejector begins to dislodge the part from the core pin, an air blast applied can assist the part in coming off the last bit of the core pin. The air blast is not intended to do the primary unseating as the sleeve ejector does this, but the air blast is intended as an assist to ensure the nearly completed ejected part is forcefully and completely removed from the pin. The use of the air blast is more useful in a gravity drop escapement as if a robot arm is used this would be less helpful.

It is understood by those skilled in the art that the sequence of events of the release state 32 may be done as taught or be done in a different order. For example, the frustoconical core 61 may be removed first while keeping the sleeve ejector mold portion in place. Thereafter, either the mold portions 50 and 55 may be removed or the mold portion 40 removed.

Once the casing 11 has been removed from the injection mold of the present invention, the casing is as shown in FIG. 4. To achieve the structure of FIG. 2, a final step of thermal swagging may be utilized to narrow the open end of the casing. This swagging operation was taught in FIG. 21 of U.S. Patent 12,066,279 and is incorporated herein with this teaching.

A draft angle 62 is shown on the inside cylindrical surface 24. The outside cylindrical surface 23 can have no draft angle or include a draft angle. Due to the molds 50 and 55 being removed in a direction perpendicular to the axial centerline, the draft angle 68 formed on the outside cylindrical surface can in fact be a positive or a negative draft angle.

Although several embodiments have been described in detail for purposes of illustration, various modifications may be made to each without departing from the scope and spirit of the invention. Accordingly, the invention is not to be limited, except as by the appended claims.

### Numerals:

9 annular channel, casing

10 ammunition cartridge

11 casing

12 primer

13 projectile

14 propellant

15 flash hole

16 lead

17 metal jacket

18 undercut

19 cannelure, i.e., annular rib

20 primer retention feature

21 base

22 hollow cylindrical portion

23 outside cylindrical surface

24 inside cylindrical surface

25 axial centerline

26 open end

27 open end surface

28 casing’s volume

29a first half of outside cylindrical surface of casing

29b second half of outside cylindrical surface of casing

30 injection mold

31 molding state

32 release state

33 perpendicular direction

34 aligned direction

40 base mold portion

41 annularly shaped base cavity surface

42 primer retention feature core

43 flash hole core

44 injection gate

45 flash hole core distal end

46 primer retention feature core cavity

50 first transverse mold portion

51 first half cavity surface

55 second transverse mold portion

56 second half cavity surface

60 core pin mold portion

61 frustoconical core

62 narrowing draft angle

63 frustoconical core proximal end

64 frustoconical core distal end

65 frustoconical core distal end cavity

66 flash hole core

67 flash hole core distal end

68 draft angle on outside cylindrical surface

70 sleeve ejector mold portion

71 annularly shaped top surface cavity surface

72 through hole, sleeve ejector mold portion

What is claimed is:

1. An injection mold configured for manufacturing an injection molded polymer casing for an ammunition cartridge, the injection molded polymer casing comprising a base having a primer retention feature and a flash hole, where a hollow cylindrical portion with an outside cylindrical surface opposite an inside cylindrical surface extends from the base along an axial centerline to an open end having an open end surface, the injection molding comprising five separate mold portions cooperatively delimiting a casing’s volume when cooperatively arranged into a molding state and configured to be movable away from one another to a release state to extract the injection molded polymer casing, the injection mold comprising:
a base mold portion having an annularly shaped base cavity surface, a primer retention feature core extending from the base cavity surface, and a flash hole core extending from the primer retention feature core;
wherein an injection gate is fluidically connected to the base cavity surface, the injection gate configured for injecting a melted polymer under pressure into the injection mold;
wherein the injection gate is the only injection gate of the injection mold;
a first transverse mold portion having a first half cavity surface configured to form a first half of the outside cylindrical surface of the injection molded polymer casing;
a second transverse mold portion having a second half cavity surface configured to form a second half of the outside cylindrical surface of the injection molded polymer casing;
wherein the first transverse mold portion and the second transverse mold portion are configured to move away from one another in a direction perpendicular to the axial centerline of the injection molded polymer casing;
a core pin mold portion having a frustoconical core configured for forming the inside cylindrical surface of the injection molded polymer casing;
wherein the frustoconical core has a cylindrically shaped narrowing draft angle less than zero degrees that narrows starting from a frustoconical core proximal end and moving towards a frustoconical core distal end; and
a sleeve ejector mold portion having an annularly shaped top surface cavity surface configured for forming the open end surface of the injection molded polymer casing, the sleeve ejector mold portion having a through hole wherein the core pin mold portion is configured to be disposed through the through hole of the sleeve ejector mold portion;
wherein the core pin mold portion is configured to move away from the base mold portion in a direction aligned along the axial centerline of the injection molded polymer casing;
wherein the sleeve ejector mold portion is configured to move away from the base mold portion in the direction aligned along the axial centerline of the injection molded polymer casing; and
wherein a flash hole core distal end is configured to be at least partially disposed within a frustoconical core distal end cavity.

2. A method of manufacturing the injection molded polymer casing for the ammunition cartridge of claim 1, the method comprising the steps of:
a) providing the injection mold comprising the five separate mold portions;
b) moving the five separate mold portions into the molding state;
c) injecting the melted polymer under pressure through the injection gate into the injection mold;
d) waiting a period of time for the melted polymer to solidify through cooling;
e) moving at least one of the five separate mold portions away from one another to the release state; and
f) removing the casing from the injection mold.

3. An injection mold configured for manufacturing an injection molded polymer casing for an ammunition cartridge, the injection molded polymer casing comprising a base having a primer retention feature and a flash hole, where a hollow cylindrical portion with an outside cylindrical surface opposite an inside cylindrical surface extends from the base along an axial centerline to an open end having an open end surface, the injection molding comprising five separate mold portions cooperatively delimiting a casing’s volume when cooperatively arranged into a molding state and configured to be movable away from one another to a release state to extract the injection molded polymer casing, the injection mold comprising:
a base mold portion having an annularly shaped base cavity surface and a primer retention feature core extending from the base cavity surface;
a first transverse mold portion having a first half cavity surface configured to form a first half of the outside cylindrical surface of the injection molded polymer casing;
a second transverse mold portion having a second half cavity surface configured to form a second half of the outside cylindrical surface of the injection molded polymer casing;
wherein the first transverse mold portion and the second transverse mold portion are configured to move away from one another in a direction perpendicular to the axial centerline of the injection molded polymer casing;
a core pin mold portion having a frustoconical core configured for forming the inside cylindrical surface of the injection molded polymer casing; and
a sleeve ejector mold portion having an annularly shaped top surface cavity surface configured for forming the open end surface of the injection molded polymer casing, the sleeve ejector mold portion having a through hole wherein the core pin mold portion is configured to be disposed through the through hole of the sleeve ejector mold portion;
wherein the core pin mold portion is configured to move away from the base mold portion in a direction aligned along the axial centerline of the injection molded polymer casing; and
wherein the sleeve ejector mold portion is configured to move away from the base mold portion in the direction aligned along the axial centerline of the injection molded polymer casing.

4. The injection mold of claim 3, wherein an injection gate is fluidically connected to the base cavity surface, the injection gate configured for injecting a melted polymer under pressure into the injection mold.

5. The injection mold of claim 4, wherein the injection gate is the only injection gate of the injection mold.

6. The injection mold of claim 3, wherein the frustoconical core has a cylindrically shaped narrowing draft angle configured to allow axial withdrawal that narrows starting from a frustoconical core proximal end and moving towards a frustoconical core distal end.

7. The injection mold of claim 6, wherein a flash hole core extends from the primer retention feature core of the base mold portion.

8. The injection mold of claim 7, wherein a flash hole core distal end is configured to be at least partially disposed within a frustoconical core distal end cavity.

9. The injection mold of claim 6, wherein a flash hole core extends from the frustoconical core distal end of the core pin mold portion.

10. The injection mold of claim 9, wherein a flash hole core distal end is configured to be at least partially disposed within a primer retention feature core cavity.

11. The injection mold of claim 1, including the injection molded polymer casing wherein the injection molded polymer casing has a base resin of PC/PBT.

12. The injection mold of claim 11, wherein the base resin of PC/PBT includes up to 10% carbon fiber additive by weight.

13. The injection mold of claim 11, wherein the base resin of PC/PBT includes a maximum of 2% carbon nanotubes by weight.

14. The injection mold of claim 11, wherein the base resin of PC/PBT has PC from 1%-99% by weight with PBT being the remainder by weight.

15. The injection mold of claim 11, wherein the base resin of PC/PBT includes a carbon fiber additive being 0.5% to 50% by weight.

16. The injection mold of claim 11, wherein the base resin of PC/PBT includes carbon nanotubes being 0.5% to 50% by weight.

17. A method of manufacturing an injection molded polymer casing for an ammunition cartridge, the injection molded polymer casing comprising a base having a primer retention feature and a flash hole, where a hollow cylindrical portion with an outside cylindrical surface opposite an inside cylindrical surface extends from the base along an axial centerline to an open end having an open end surface, the method comprising the steps of:
a) providing an injection mold consisting of five separate mold portions cooperatively delimiting a casing’s volume when cooperatively arranged into a molding state and configured to be movable away from one another to a release state to extract the injection molded polymer casing, the five separate mold portions being:
a base mold portion having an annularly shaped base cavity surface, a primer retention feature core extending from the base cavity surface, and a flash hole core extending from the primer retention feature core;
wherein an injection gate is fluidically connected to the base cavity surface, the injection gate configured to inject a melted polymer under pressure into the injection mold;
wherein the injection gate is the only injection gate of the injection mold;
a first transverse mold portion having a first half cavity surface configured to form a first half of the outside cylindrical surface of the injection molded polymer casing;
a second transverse mold portion having a second half cavity surface configured to form a second half of the outside cylindrical surface of the injection molded polymer casing;
wherein the first transverse mold portion and the second transverse mold portion are configured to move away from one another in a direction perpendicular to the axial centerline of the injection molded polymer casing;
a core pin mold portion having a frustoconical core configured for forming the inside cylindrical surface of the injection molded polymer casing;
wherein the frustoconical core has a cylindrically shaped narrowing draft angle configured to allow axial withdrawal that narrows starting from a frustoconical core proximal end and moving towards a frustoconical core distal end; and
a sleeve ejector mold portion having an annularly shaped top surface cavity surface configured for forming the open end surface of the injection molded polymer casing, the sleeve ejector mold portion having a through hole wherein the core pin mold portion is configured to be disposed through the through hole of the sleeve ejector mold portion;
wherein the core pin mold portion is configured to move away from the base mold portion in a direction aligned along the axial centerline of the injection molded polymer casing;
wherein the sleeve ejector mold portion is configured to move away from the base mold portion in the direction aligned along the axial centerline of the injection molded polymer casing;
wherein a flash hole core distal end is configured to be at least partially disposed within a frustoconical core distal end cavity;
b) moving the five separate mold portions into the molding state;
c) injecting the melted polymer under pressure through the injection gate into the injection mold;
d) waiting a period of time for the melted polymer to harden through cooling;
e) moving at least one of the five separate mold portions away from one another to the release state; and
f) removing the casing from the injection mold.
